(19) United States
(12) Patent Application Publication
(10) Pub. No.: US 2026/0351635 A1
(43) Pub. Date: Nov. 5, 2026

(54) Computer-Implemented Method for Detecting Purging in a Fuel Cell

(71) Applicant: Bayerische Motoren Werke Aktiengesellschaft, Muenchen (DE)

(72) Inventor: Thomas RAUH, Eching (DE)

(21) Appl. No.: 19/113,877

(22) PCT Filed: Aug. 18, 2023
(86) PCT No.: PCT/EP2023/072785

§ 371 Date: Mar. 20, 2025

(30) Foreign Application Priority Data
Sep. 20, 2022 (DE) 10 2022 124 128.9

(51) Int. Cl. H01M 8/0438; H01M 8/04223; H01M 8/04537

(52) U.S. Cl. CPC H01M 8/04388; H01M 8/04231; H01M 8/04432; H01M 8/04582; H01M 2250/20

(57) ABSTRACT

A computer-implemented method for detecting purging caused by an anode purge valve in a fuel cell has the steps of: detecting an actuation phase of the anode purge valve for causing purging; monitoring a first measurement variable that depends on a pressure which changes if purging takes place; monitoring a second measurement variable that influences the pressure independently of purging; in the event of a change in the first measurement variable in a monitoring period during and/or after the actuation phase, determining whether the second measurement variable has changed before or in the monitoring period; and detecting that purging is taking place under the criterion that the second measurement variable has not changed before or in the monitoring period.

### BACKGROUND AND SUMMARY

The technology disclosed here relates to a computer-implemented method for detecting purging in a fuel cell. Furthermore, the invention relates to a data processing device, a computer product, and a computer-readable storage medium.

A fuel cell comprises an anode, a membrane, and a cathode. The anode and the cathode can each have a fluid channel. A fuel such as hydrogen typically flows through the fluid channel of the anode and an oxidant such as air or oxygen flows through the fluid channel of the cathode. The fluid channels distribute the fuel and oxidant over the membrane. A chemical reaction in the fuel cell converts the reaction energy of the fuel and oxidant into electrical energy and heat. Fuel exhaust gas arises in this case. In particular, water arises in a fuel cell which uses hydrogen as a fuel.

The fuel exhaust gas or the water and possibly other byproducts can enter the fluid channel of the anode by diffusion and impair the efficiency and service life of the fuel cell therein. Therefore, purging and in particular hydrogen purging is generally performed in the anode.

It is an object of the technology disclosed here to reduce or eliminate at least one disadvantage of a previously known solution or propose an alternative solution. In particular, it is a preferred object to improve an efficiency and service life of a fuel cell in dynamic operation, thus when a driving dynamic variable takes place, in particular an acceleration and/or a deceleration. Further preferred objects can result from the advantageous effects of the technology disclosed here.

The objects are achieved by the subjects of the independent claims. The dependent claims represent preferred embodiments.

The technology disclosed here provides, according to one aspect, a computer-implemented method for detecting purging caused by means of an anode purge valve in a fuel cell, the method comprising the following steps:
detecting an actuation phase of the anode purge valve to cause purging;
monitoring a first measured variable that depends on a pressure which changes due to the purging if the purging was caused successfully, thus actually takes place;
monitoring a second measured variable which influences the pressure in addition to purging, thus independently of the case that the purging actually takes place;
in case of a change of the first measured variable in a monitoring period of time during and/or after the actuation phase, establishing whether the second measured variable has significantly changed before or in the monitoring period of time, i.e. by greater than or equal to a specified absolute value; and
detecting successfully caused or actually occurring purging under the criterion that the second measured variable has not significantly changed in the above meaning before or in the monitoring period of time.

In other words, the technology disclosed here relates to detecting whether purging which has been caused, preferably anode purging, also actually takes place. This detection is to be enabled in particular in dynamic driving operation, wherein the finding exists here that the pressure monitored by the first measured variable can also change due to the dynamic driving operation, because of which the purging is possibly not detected.

It can be established by the method in dynamic driving operation, in which the second measured variable can change, whether the anode purge valve correctly opens or closes during an actuation phase.

The controller of a fuel cell system can establish for this purpose during an actuation phase of the anode purge valve whether the anode purge valve actually switches and/or with which efficiency, for example, the water is discharged from the system. A detection of purging would otherwise have to take place, for example, via additional sensors, for example, by a plausibility check via a hydrogen sensor in the exhaust gas line.

One concept of preferred embodiments is to progressively monitor a first measured variable that depends on a pressure which changes due to purging, in particular in the dynamic system operation. For example, the first measured variable is the anode pressure. It is therefore preferred for the monitoring of the first measured variable and/or the monitoring of the second measured variable to take place progressively. The pressure sensor or sensors present in the anode can be used for the monitoring. Therefore, no additional sensors are necessary.

If purging were not actually or effectively to be carried out for a longer time depending on the exhaust gas or water production of the fuel cell or a stack of fuel cells, this can be between 30 seconds and 10 minutes—then this would result in significant aging or damage to the fuel cell or the stack of fuel cells up to total failure of the system. This would require a replacement of the fuel cell or a replacement of the complete stack of fuel cells.

It is preferred for the method to furthermore comprise the following step:
detecting purging actually taking place under an additional criterion which can be designed in different embodiments according to the following description.

It is preferred for the method to furthermore comprise the following step: in case of a change of the first measured variable in the monitoring period of time, determining the absolute value of the change. It is then preferred that the additional criterion is that the absolute value is greater than or equal to a specified absolute value.

It is preferred for the method to furthermore comprise the following step:
in case of a change of the first measured variable in the monitoring period of time, determining a curve characteristic of the change.

It is then preferred for the additional criterion to be that the curve characteristic corresponds to a specified characteristic. Such a specified characteristic can have a tolerance range or a tolerance band, so that there does not have to be exact correspondence with a single curve profile. The specified characteristic can provide, for example, an upper and a lower limiting course, between which the tolerance band lies, in which the curve characteristic has to lie so that correspondence is detected.

It is preferred for the specified characteristic to comprise the slope of the change and/or the boundary of the change in a course of time before it. A transition or a relative change to a preceding course of time is thus monitored for an additional criterion, for example, a relative change by more than a specified percentage.

It is preferred for the additional criterion to be that the absolute value is greater than or equal to the specified absolute value and that the curve characteristic corresponds to the specified characteristic, thus that combined monitoring takes place.

It is preferred for the first measured variable to be a pressure in a fluid channel of the fuel cell or to comprise this (for example, in the case of a combined measurement).

It is preferred for the fluid channel to be arranged on an anode of the fuel cell.

It is preferred for the first measured variable to be a pressure difference between an input pressure and an output pressure in a fluid channel or to comprise this (for example, in the case of a combined measurement). For example, the first measured variable can be a pressure difference between an anode input pressure and an anode output pressure.

The method can also be carried out by means of only one pressure sensor and this does not necessarily have to be attached in the anode. The pressure sensor or sensors can also be located outside the anode in a fluid channel up to the ambient air. For example, the method can be implemented via a moderate pressure/high pressure sensor. The preferred implementation via one or more anode sensors has the least time difference from the triggering purging, however, and is therefore the simplest to apply.

It is preferred for the second measured variable to be a pressure on an anode of the fuel cell or to comprise this (for example, in the case of a combined measurement). A setpoint pressure can also be detected as the pressure, which a regulator can specify for the electrical power generation as a function of a required driving power. The reason for this is the finding that it can be presumed that the course of the pressure in the anode reliably follows the setpoint pressure. The second measured variable can also be an electric current in the fuel cell or can comprise this (for example, in the case of a combined measurement).

It is preferred for the second measured variable to be a consumption of fuel or hydrogen in the fuel cell or to comprise this (in the case of a combined measurement).

The “combined measurement” mentioned here means that the second measured variable can also be composed of a combination of multiple measured variables. One measured variable can also be preprocessed by short-term averaging.

It is preferred for the establishment of whether the second measured variable has changed before or in the monitoring period of time by greater than or equal to the specified value to begin 10-1000 ms, preferably 50 -250 ms, more preferably 90-110 ms before the monitoring period of time. This can be carried out, for example, by cyclic monitoring independently of the actuation phase.

It is preferred for the monitoring period of time to begin with the actuation phase.

It is preferred for the monitoring period of time to end with or within 1000 ms, preferably within 500 ms, more preferably within 250 ms after the actuation phase.

If a check for purging detects that no purging has taken place, in reaction thereto, an error signal can be generated or an operation of the motor vehicle can be restricted.

It is preferred for the method to furthermore comprise the following step:
averaging the detection of purging over multiple actuation phases. Individual purging which is unsuccessful or does not take place is prevented from resulting in the error signal or the restriction in this way.

In a preferred embodiment of the method, three assessment criteria can be checked, namely:
K1) whether a change of the first measured variable was detected in a monitoring period of time having an absolute value greater than or equal to a specified absolute value, for example, whether a sufficient pressure drop (absolute level change of the pressure event) was detected;
K2) whether the curve characteristic of the change of the first measured variable in the monitoring period of time corresponds to a specified characteristic, for example, whether the pressure drop corresponds to typical purging (high level of dynamics and clear boundary of the pressure event); and
K3) that the second measured variable has changed before or in the monitoring period of time in absolute value by less than a specified threshold value, i.e. that no external influences on the pressure exist.

Rapidly changing external influences can be, for example, a pressure change on the anode (very frequently observed) or a sudden change of the H₂ consumption, which corresponds to a sudden current change (extremely rare).

All criteria K1), K2), and K3) can preferably be checked over the entire actuation or monitoring phase, wherein the change of the first measured variable due to liquid water effects can also occur with a slight delay. The second measured variable, i.e. the external influences, can even be checked before the beginning of the actuation phase, for example, 100 ms in the past, so that an immediately preceding event cannot trigger a “false positive” detection.

The result can be evaluated as follows:
a) if at least one criterion K1), K2), or K3) does not achieve significance in the check, i.e. at least one criterion K1), K2), or K3) is not met, then this is assessed as an unsuccessful actuation phase without purging.
b) if all three criteria K1), K2), and K3) are met, then this is assessed as a successful actuation phase with purging.

The technology disclosed here provides, according to a further aspect, a data processing device, which comprises means for carrying out the method according to one of the preceding embodiments. The data processing device can be implemented by a control unit or a composite made up of multiple networked control units of the motor vehicle. The means can provide at least one microprocessor and/or at least one microcontroller. The at least one sensor described can also be provided to implement the system.

The technology disclosed here provides, according to a further aspect, a motor vehicle having an anode purge valve in a fuel cell and having an embodiment of the data processing device.

The technology disclosed here provides, according to a further aspect, a computer program, comprising program instructions which, upon execution by a microprocessor, cause it to carry out the method according to one of the preceding embodiments.

The technology disclosed here provides, according to a further aspect, a computer-readable storage medium, on which the computer program is stored.

The technology disclosed here will now be explained on the basis of the figures.

### BRIEF DESCRIPTION OF THE DRAWINGS

FIG. 1 is a schematic representation of a computer-implemented method for detecting purging according to one embodiment of the invention;

FIG. 2 is a schematic representation of the computer-implemented method for detecting purging according to another embodiment of the invention;

FIG. 3 shows an example of an evaluation according to the method shown in FIG. 2;

FIG. 4 shows another example of an evaluation according to the method shown in FIG. 2;

FIGS. 5 and 6 show measurement examples of the method shown in FIG. 2; and

FIG. 7 shows a measurement example of an alternative method.

### DETAILED DESCRIPTION OF THE DRAWINGS

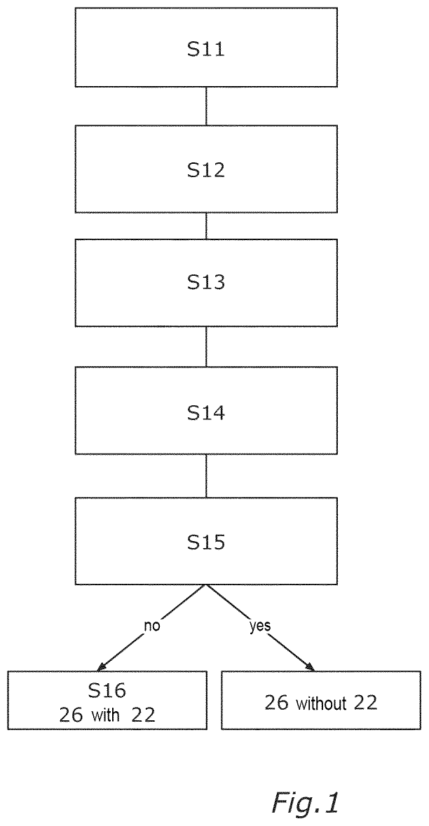

In the following description of the exemplary embodiments shown in FIGS. 1 to 7, identical reference signs are used for features which are identical and/or at least comparable in their design and/or mode of operation. If they are not explained in detail once again, the design and/or mode of operation thereof corresponds to the design and/or mode of operation of the features already described above.

A computer-implemented method will be described hereinafter on the basis of a fuel cell 10 (not shown in more detail). This can be installed in a motor vehicle and operated during a journey.

The fuel cell 10 comprises an anode 12, a membrane 14, and a cathode 16. The anode 12 and the cathode 16 can each have a fluid channel 18. The fluid channel 18 in the anode 12 has an anode purge valve 20 for carrying out purging 22. The anode purge valve 20 can be opened and closed by a controller 24 of the fuel cell 10. The opening and closing of the anode purge valve 20 preferably takes place periodically here.

Purging 22, during which the anode purge valve 20 is opened for a specific time and then closed again, can remove fuel exhaust gas of the chemical reaction in the fuel cell 10 from the fluid channel 18 of the anode 14.

The computer-implemented method for detecting purging 22 according to one embodiment of the invention will be described hereinafter with reference to FIG. 1.

The method comprises step S11:
detecting an actuation phase 26 of the anode purge valve 20 to cause purging 22.

In other words, the controller 24 can actuate the anode purge valve 20 during an actuation phase 26 and give commands or signals to open or close to the anode purge valve 20. This actuation phase 26 is detected in the method.

The method furthermore comprises step S12:
monitoring a first measured variable 28 that depends on a pressure 30 which changes due to purging 22.

The first measured variable 28 depends on a pressure 30, which changes due to purging 22. For example, a pressure 30 in the anode 12 can change during purging 22. The first measured variable 28 also changes due to the purging 22. The first measured variable 28 is monitored, preferably progressively.

The method furthermore comprises step S13:
monitoring a second measured variable 32, which likewise influences the pressure 30 in addition to purging 22 or independently of the purging 22.

In other words, the second measured variable 32 influences the pressure 30 independently of the purging 22. The second measured variable 32 can represent the influences on the pressure 30 which are not caused by the purging 22.

The second measured variable 32 can substantially change in dynamic driving operation. Dynamic driving operation is understood here, for example, to mean that the driver has an influence on the operation of the fuel cell 10 due to their driving style.

For example, the second measured variable 32 can be a pressure on the anode 12 of the fuel cell 10 and/or an electric current in the fuel cell 10 and/or a consumption of fuel in the fuel cell 10.

In particular, the second measured variable 32 can be a setpoint pressure, influenced by the driver, in the fuel cell 10. The setpoint pressure can rise steadily or fall steadily in the dynamic driving operation, for example, because a corresponding demand for electric power from the fuel cell is demanded by acceleration and/or deceleration of the vehicle. This has the result that the setpoint pressure is specified accordingly by a regulator (known from the prior art) in order to generate the requested electrical power.

The detection of an actuation phase 26, the monitoring of the first measured variable 28, and the monitoring of the second measured variable 32 can take place in parallel or sequentially over time.

The method furthermore comprises steps S14 and S15:
in case of a change of the first measured variable 28 in a monitoring period of time 34 during and/or after the actuation phase 26 (step S14), establishing whether the second measured variable 32 has changed by more than a threshold value before or in the monitoring period of time 34 (step S15).

In other words, a change of the first measured variable 28 is established in a period of time in which the first measured variable 28 is monitored and which runs during and/or after the actuation phase 26.

The monitoring period of time 34 can correspond, for example, to the actuation phase 26, but does not have to. The change of the first measured variable 28 can also be monitored with a time delay from the actuation phase 26.

Furthermore, it is checked whether the second measured variable 32 has substantially changed in the described sense before or in the monitoring period of time 34. As mentioned above, a substantial change of the second measured variable 32 can be caused by the dynamic driving operation.

A substantial change of the second measured variable 32 is preferably to be understood as a change of the second measured variable 32 such that the influence of purging 22 on the pressure 30 can no longer be distinguished from the influence of the second measured variable 32 on the pressure 30.

To establish a substantial change of the second measured variable 32, for example, a threshold 35 can be defined, which the change of the second measured variable 32 has to exceed. The threshold 35 can be an absolute threshold or a threshold relative to a starting value. For example, the threshold 35 can be exceeded in the event of a relative change of the second measured variable 32 by a percentage or in the event of a relative change of the second measured variable 32 by N-fold, wherein N can be any number greater than one.

To establish a substantial change of the second measured variable 32, the second measured variable 32 can also be averaged over a chronological averaging range running along with time (moving average). If the value of the second measured variable 32 averaged over the chronological averaging range exceeds the threshold 35, a substantial change of the second measured variable 32 can be established.

Other possibilities for establishing a substantial change of the second measured variable 32, for example, via ascertaining a slope of the change of the second measured variable 32, are conceivable.

In a further step of the method S16:
detecting purging 22 under the criterion K3 that the second measured variable 32 has not substantially changed before or in the monitoring period of time 34, it is checked whether the second measured variable 32 has or had influence on the pressure 30 before or in the monitoring period of time 34. This is viewed as an indication that the substantial change of the second measured variable 32 was causative for the change of the first measured variable 28. This is therefore assessed as an actuation phase 26 without purging 22.

Under the criterion K3 that the second measured variable 32 has not substantially changed before or in the monitoring period of time 34, it is concluded therefrom that the opening and closing of the anode purge valve 20 was causative for the change of the first measured variable 28. This is therefore assessed as an actuation phase 26 with purging 22.

For the assessment of whether the anode purge valve 20 correctly opens or closes during an actuation phase 26, the moments are therefore excluded which correspond to a dynamic driving operation. If these moments were incorporated, it would not be possible to reliably establish in a dynamic driving operation whether the anode purge valve 20 correctly opens or closes.

Preferably, for example, the threshold 35 used to establish the substantial change of the second measured variable 32 is defined such that in the event of a change of the second measured variable 32 below the threshold 35, an influence of the second measured variable 32 on the pressure 30 can be excluded with a high probability. Purging 20 can thus also be detected with a high probability.

In contrast, if the second measured variable 32 exceeds the threshold, an influence of the second measured variable 32 can no longer be excluded with a high probability, so that preferably no purging 20 is detected even in the case of actual purging 20.

The risk of incorrect detection of purging 20, although no actual purging 20 has taken place, can therefore be reduced. The risk of damage or even total failure of the fuel cell 10 is therefore also reduced.

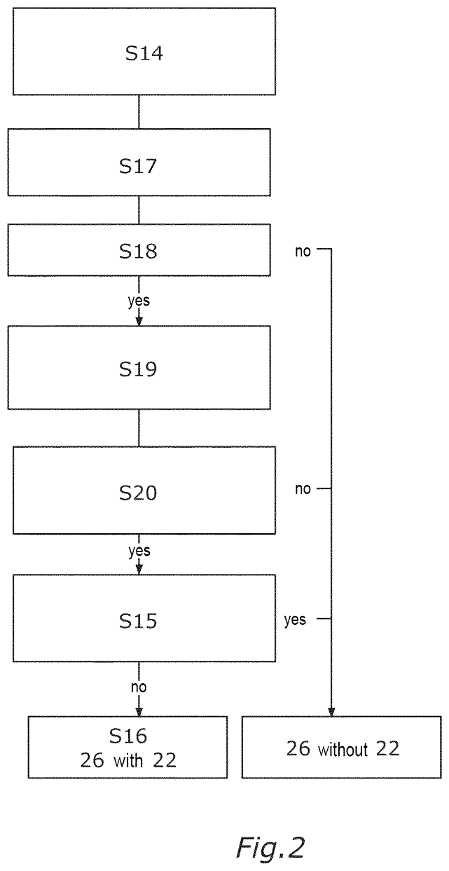

FIG. 2 shows a schematic representation of the method according to a further embodiment of the invention.

For better clarity, steps S11, S12, and S13:
detecting an actuation phase 26 of the anode purge valve 20 to cause purging 22 (step S11);
monitoring a first measured variable 28 that depends on a pressure 30, which changes due to purging 22 (step S12); and
monitoring a second measured variable 32, which influences the pressure 30 in addition to purging 22 (step S13), are not shown in FIG. 2. The method according to FIG. 2 can include the preceding steps, however.

In the method shown in FIG. 2, additional criteria K1 and K2 are upstream from the criterion K3. However, any other sequence of the criteria K1, K2, K3 is possible and the check of the criteria K1, K2, and K3 can take place in parallel or sequentially over time. In addition, embodiments of the invention are also possible in which only one of the additional criteria K1 or K2 is implemented.

The method shown in FIG. 2 comprises steps S14 and S17:
in the case of a change of the first measured variable 28 in the monitoring period of time 34 (step S14), determining the absolute value 36 of the change of the first measured variable 28 (step S17).

It is then checked in step S18 whether the absolute value 36 is greater than or equal to a specified absolute value 38.

If the absolute value 36 is not greater than or equal to the specified absolute value 38, this is assessed as an actuation phase 26 without purging 22.

Furthermore, the method comprises step S19:
determining a curve characteristic 40 of the change of the first measured variable 28.

The curve characteristic 40 can be, for example, a slope of the change of the measured variable 28. The curve characteristic 40 can also be a smoothed or averaged function of the change of the first measured variable 28. Furthermore, the curve characteristic 40 can be the property of the extent to which the change of the first measured variable 28 in the monitoring period of time 34 is bounded in relation to periods of time outside the actuation phase 26 or the monitoring period of time 34.

It is then checked in step S20 whether the curve characteristic 40 substantially corresponds to a specified characteristic 42.

If the curve characteristic 40 in the described sense does not substantially correspond to a specified characteristic 42, this is assessed as an actuation phase 26 without purging 22.

Furthermore, the method again comprises step S15:
establishing whether the second measured variable 32 has substantially changed before or in the monitoring period of time 34.

Under the criterion K1 that the absolute value 36 is greater than or equal to a specified absolute value 38, under the criterion K2 that the curve characteristic 40 substantially corresponds to a specified characteristic 42, and under the criterion K3 that the second measured variable 32 has not substantially changed before or in the monitoring period of time 34, it is concluded therefrom that the opening and closing of the anode purge valve 20 was causative for the change of the first measured variable 28. This is therefore assessed as an actuation phase 26 with purging 22 (step S16).

In a step which is not shown in FIGS. 1 and 2 but is preferred, the detection of purging 22 can be averaged over multiple actuation phases 26. This can improve the reliability of the confirmation that the anode purge valve 20 correctly opens or closes. The means can comprise, for example, that it is counted how many detections of successful purging and how many detections of unsuccessful purging have occurred, and specifies a percentage (for example, less than 75% successful), below which the error signal or the operating restriction is triggered.

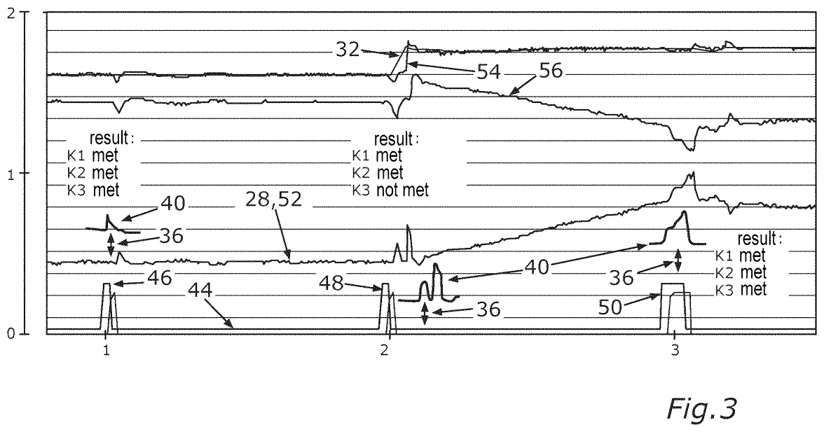

FIG. 3 shows an example of an evaluation according to the method shown in FIG. 2.

FIG. 3 shows, inter alia, an actuation signal 44 in the course of time. The actuation signal 44 has a first actuation phase 46, a second actuation phase 48, and a third actuation phase 50. The actuation phases 46, 48, 50 stand out from the background of the actuation signal 44 due to a substantially rectangular signal.

The first measured variable 28 corresponds in the example shown in FIG. 3 to a pressure difference 52 of an anode input pressure 54 and an anode output pressure 56.

Furthermore, FIG. 3 indicates the absolute value 36 of the change of the first measured variable 28, i.e. the absolute value 36 of the change of the pressure difference 52 (for criterion K1).

Furthermore, FIG. 3 shows the curve characteristic 40 of the change of the first measured variable 28 in the monitoring period of time 34, i.e. the curve characteristic 40 of the change of the pressure difference 52 (for criterion K2).

Furthermore, FIG. 3 shows the second measured variable 32 (for criterion K3).

The first actuation phase 46 and the third actuation phase 50 meet the three criteria K1, K2, and K3. These actuation phases 46, 50 are therefore assessed as actuation phases 26 with purging 22. The second actuation phase 48 meets the criteria K1 and K2, but not the criterion K3. The second actuation phase 48 is therefore assessed as an actuation phase 26 without purging 22.

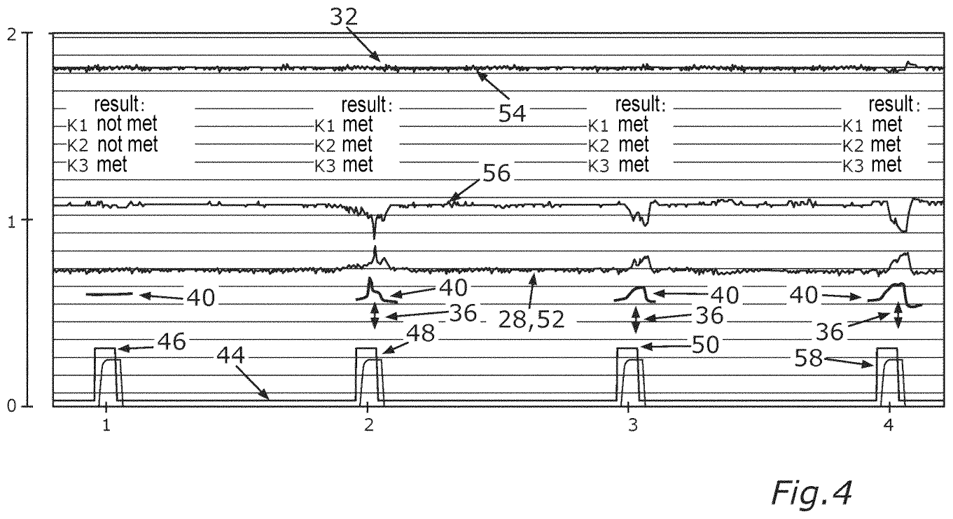

FIG. 4 shows a further example of an evaluation according to the method shown in FIG. 2 with four actuation phases 46, 48, 50, 58.

The second measured variable 32 does not show any substantial change over the entire course. The criterion K3 is therefore met for the four actuation phases 46, 48, 50, 58.

The first actuation phase 46 meets neither the criterion K1 nor the criterion K2. This actuation phase 46 is therefore assessed as an actuation phase 26 without purging 22.

The second actuation phase 48, the third actuation phase 50, and the fourth actuation phase 58 also meet the criteria K1 and K2. These actuation phases 48, 50, 58 are therefore assessed as actuation phases 26 with purging 22.

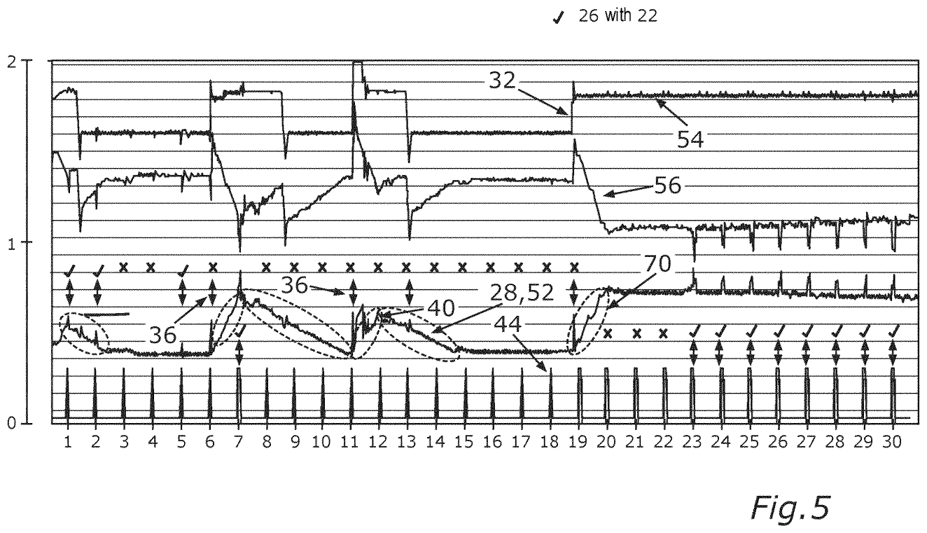

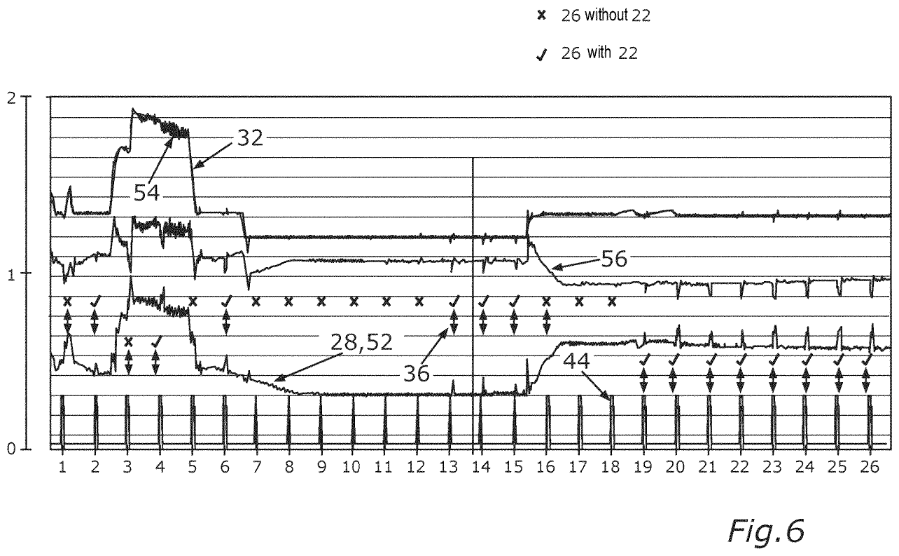

FIGS. 5 and 6 show measurement examples which were carried out on a fuel cell 10 having an anode purge valve 20 of a vehicle 60 in a dynamic driving operation.

The actuation signal 44 has a plurality of actuation phases 26, which are executed periodically. The first measured variable 28 corresponds, as in FIGS. 3 and 4, to the pressure difference 52 of the anode input pressure 54 and the anode output pressure 56. The method reliably distinguishes actuation phases 26 with purging 22 (identified by a check) from actuation phases 26 without purging 22 (identified by an X).

The ellipses 70 indicate current influences, which do not rise suddenly and can be distinguished from the short actuation phases 26 with purging processes 22.

The embodiments of the method described with respect to FIGS. 1 and 2 can be carried out by a suitable data processing device 64 (not shown in greater detail). Furthermore, embodiments of the method can be implemented in a computer program 66 (not shown in greater detail) by means of program instructions. The computer program 66 can additionally be stored on a computer-readable storage medium 68 (not shown in greater detail).

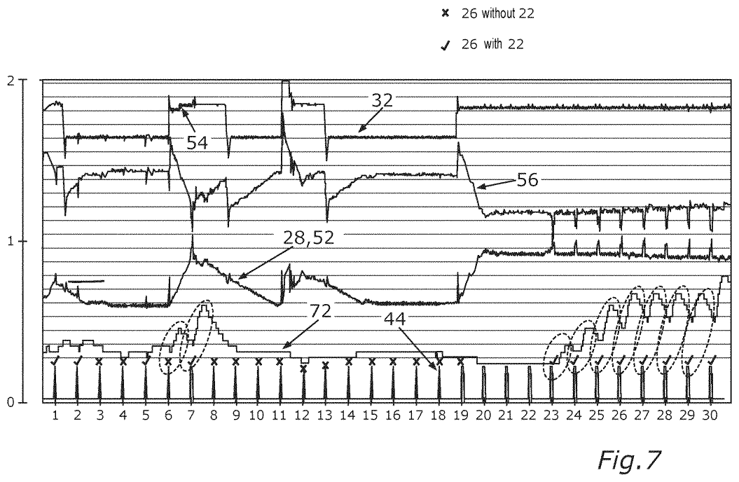

Alternatively to the embodiments of the method described with respect to FIGS. 1 and 2, a fuel sensor can be used, for example, a hydrogen sensor. However, a further sensor is required for this purpose. A measurement example of this alternative method for detecting purging is shown in FIG. 7, in which the course over time of a fuel measured variable 72 is shown.

One principle of preferred embodiments of the invention can therefore be described in summary as follows:

It is therefore preferably progressively monitored for the detection of purging whether an actuation of the anode purge valve takes place. As soon as an actuation phase has been detected, the first measured variable, for example, the pressure difference between the anode input pressure and the anode output pressure, is evaluated. The actuation phase can be detected, for example, from a switching signal which is to control the anode purge valve.

During the actuation phases of the anode purge valve, the change of the first measured variable is monitored and analyzed for known influences by the anode purge valve. The first measured variable can be a pressure level, in particular a pressure difference of two pressure sensors in the anode. If the actuation of the anode purge valve is assessed as a significant influence on the pressure, via this and, particularly preferably, averaged over multiple actuation phases-the unambiguous and sufficient actuation of the anode purge valve can be derived. The valid or successful actuation can hereby be confirmed, by which the functionality is monitored progressively and in particular also in dynamic operation.

The term “substantially” (for example, “substantially perpendicular axis”) comprises in the context of the technology disclosed here in each case the precise property or the precise value (for example, “perpendicular axis”) and in each case deviations unimportant for the function of the property/the value (for example, “tolerable deviation or tolerances”).

The preceding description of the present invention serves only for illustrative purposes and not for the purpose of restricting the invention. Various changes and modifications are possible in the scope of the invention without departing from the scope of the invention and its equivalents.

### LIST OF REFERENCE SIGNS

10 fuel cell
12 anode
14 membrane
16 cathode
18 fluid channel
20 anode purge valve
22 purging
24 controller
26 actuation phase
28 first measured variable
30 pressure
32 second measured variable
34 monitoring period of time
35 threshold
36 absolute value
38 specified absolute value
40 curve characteristic
42 specified characteristic
44 actuation signal
46 first actuation phase
48 second actuation phase
50 third actuation phase
52 pressure difference
54 anode input pressure
56 anode output pressure
58 fourth actuation phase
60 vehicle
62 current
64 data processing device
66 computer program
68 computer-readable storage medium
70 ellipse
72 fuel measured variable
K1, K2, K3 criterion

1.-11. (canceled)

12. A computer-implemented method for detecting purging caused by an anode purge valve in a fuel cell, the method comprising the steps of:
detecting an actuation phase of the anode purge valve to cause the purging;
monitoring a first measured variable that depends on a pressure which changes in case of purging actually taking place;
monitoring a second measured variable which influences the pressure independently of the purging taking place;
in case of a change of the first measured variable in a monitoring period of time during and/or after the actuation phase, establishing whether the second measured variable has changed by greater than or equal to a defined absolute value before or in the monitoring period of time; and
detecting purging taking place under a criterion that the second measured variable has changed in absolute value by less than a defined threshold value before or in the monitoring period of time.

13. The method according to claim 12, further comprising the steps of:
in case of a change of the first measured variable in the monitoring period of time, determining the absolute value of the change of the first measured variable; and
detecting purging taking place under an additional criterion that the absolute value is greater than or equal to a defined absolute value.

14. The method according to claim 12, further comprising the steps of:
in case of a change of the first measured variable in the monitoring period of time, determining a curve characteristic of the change of the first measured variable; and
detecting purging taking place under an additional criterion that the curve characteristic corresponds to a specified characteristic.

15. The method according to claim 12, wherein
the first measured variable is the pressure in a fluid channel of the fuel cell, wherein the fluid channel is arranged on an anode of the fuel cell; and/or
the first measured variable is a pressure difference between an input pressure or anode input pressure, on the one hand, and an output pressure or anode output pressure in a fluid channel, on the other hand.

16. The method according to claim 15, wherein
the second measured variable is a pressure on an anode of the fuel cell and/or a current in the fuel cell and/or a consumption of fuel in the fuel cell.

17. The method according to claim 12, wherein
the second measured variable is a pressure on an anode of the fuel cell and/or a current in the fuel cell and/or a consumption of fuel in the fuel cell.

18. The method according to claim 12, wherein
the establishing begins 10-1000 ms before the monitoring period of time, and/or
the monitoring period of time begins with the actuation phase and/or the monitoring period of time ends with up to 1000 ms after the actuation phase.

19. The method according to claim 12, further comprising the step of:
averaging the detecting of purging taking place over multiple actuation phases.

20. A data processing device comprising a processor and associated memory operatively configured to:
detect an actuation phase of the anode purge valve to cause the purging;
monitor a first measured variable that depends on a pressure which changes in case of purging actually taking place;
monitor a second measured variable which influences the pressure independently of the purging taking place;
in case of a change of the first measured variable in a monitoring period of time during and/or after the actuation phase, establish whether the second measured variable has changed by greater than or equal to a defined absolute value before or in the monitoring period of time; and
detect purging taking place under a criterion that the second measured variable has changed in absolute value by less than a defined threshold value before or in the monitoring period of time.

21. A computer product comprising a non-transitory computer-readable medium having stored thereon program instructions which, upon execution by a microprocessor, carry out the acts of:
detecting an actuation phase of the anode purge valve to cause the purging;
monitoring a first measured variable that depends on a pressure which changes in case of purging actually taking place;
monitoring a second measured variable which influences the pressure independently of the purging taking place;
in case of a change of the first measured variable in a monitoring period of time during and/or after the actuation phase, establishing whether the second measured variable has changed by greater than or equal to a defined absolute value before or in the monitoring period of time; and
detecting purging taking place under a criterion that the second measured variable has changed in absolute value by less than a defined threshold value before or in the monitoring period of time.

22. A motor vehicle, comprising:
an anode purge valve in a fuel cell; and
a data processing device according to claim 20.
